(19) United States
(12) Patent Application Publication
(10) Pub. No.: US 2003/0192816 A1
(43) Pub. Date: Oct. 16, 2003

(54) Cleaning system for animal litter and bedding

(76) Inventor: William Opfel, Mesa, AZ (US)

Correspondence Address: Kenneth C. Booth, Schmeiser, Olsen & Watts LLP, 18 East University Drive, #101, Mesa, AZ, 85201, US

(21) Appl. No.: 10/411,407

(22) Filed: Apr. 9, 2003

Related U.S. Application Data
(63) Continuation-in-part of application No. 10/188,611, filed on Jul. 2, 2002.
Application No. 10/188,611 is a continuation-in-part of application No. 10/120,858, filed on Apr. 10, 2002.
(60) Provisional application No. 60/371,783, filed on Apr. 10, 2002.
(60) Provisional application No. 60/431,106, filed on Dec. 4, 2002.

(51) Int. Cl. B07B 4/00

(52) U.S. Cl. 209/133; 209/138

(57) ABSTRACT

A cleaning system is disclosed for cleaning contaminants from animal litter. In a first embodiment of the invention, a vacuum and a blower are coupled together and configured so that the blower blows a first fluid stream into animal litter simultaneous with the vacuum drawing a second fluid stream from the animal litter. Relatively light contaminants are drawn into the vacuum while the relatively heavy animal litter is left behind. In a second embodiment of the invention, a cyclonic separator is used to draw the animal litter and the intermixed contaminants into the cyclonic separator simultaneously, and separate the animal litter from the contaminants. The animal litter is returned to the area from which it was removed. In a third embodiment of the invention, mechanical agitation is coupled with air separation to further enhance separation of contaminants from the animal litter. The embodiments of the invention have particular use in cleaning horse stalls to separate the horse bedding from the allergens which collect in the horse bedding over time and present health risks to the horse, and return the horse bedding for continued use. Embodiments of the invention prolong the usefulness of the horse bedding, promote a healthy environment for the horse, and reduce the overall maintenance and health care costs for the horse.

### RELATED APPLICATION

This application is a continuation-in-part application of U.S. Utility patent application to William Opfel, Ser. No. 10/120,858, titled “ANIMAL LITTER AND METHODS OF FABRICATING SAME,” filed on Apr. 10, 2002, and is a continuation-in-part application of U.S. Utility patent application Ser. No. 10/188,611, filed on Jul. 2, 2002, entitled “CLEANING SYSTEM FOR ANIMAL LITTER AND BEDDING” which claims priority to U.S. Provisional Patent Application Serial No. 60/371,783, filed on Apr. 10, 2002, entitled “CLEANING SYSTEM FOR ANIMAL LITTER”. This application also claims priority to U.S. Provisional Patent Application Serial No. 60/431,106, filed on Dec. 4, 2002, entitled “CLEANING SYSTEM FOR ANIMAL LITTER AND BEDDING”.

### BACKGROUND OF THE INVENTION

1. Technical Field

This invention generally relates to a method and apparatus for cleaning animal litter for reuse, and more particularly to cleaning allergens, germs and other light-weight contaminants from animal litter and bedding.

2. Background Art

Animal bedding, also called animal litter in the small animal industry (collectively referred to herein as “bedding”), is a common hiding place for many allergens such as animal hair and fur, dander, dust mites, dust, dirt, protein from decomposing animal feces, and the like, and for germs such as bacteria, viruses and fungi, and the like. Allergens and germs can be a problem not only for the animal using the bedding, but for the care givers of the animal. Both the animal and the care giver may develop respiratory ailments and diseases, hair loss, rashes and the like from common allergens and germs present in the animal bedding. Horse stalls are typically overwhelmed with as much as 15-30 gallons of urine and 10-50 pounds of manure per day, per animal. While much of the obvious animal waste can be removed directly from the horse bedding, portions of the animal waste, and the smaller allergens and germs can not. The present solution to the problem of allergens, germs and other contaminants is to remove the contaminated bedding and replace it with new bedding frequently. While this approach is effective, it can also be monetarily as well as environmentally expensive to dispose of the contaminated bedding materials, and to use new bedding in the stall frequently. Typically, bedding materials are replaced daily, weekly or monthly to remove the contaminants. There is presently no known system available for easily separating the contaminants from the bedding to enable the bedding to be reused without the contaminants.

### DISCLOSURE OF THE INVENTION

A first aspect of the present invention relates to a system for removing allergens and other contaminants from animal bedding by stirring up the relatively heavy animal bedding to gain access to and loosen relatively light contaminant material for removal from the bedding. As used herein, the term “bedding” and “animal bedding” is considered to be interchangeable with the terms “litter” and “animal litter”. In the small animal industry, for example the cat industry, the terms “litter” and “animal litter” are commonly used to refer to the material on which the animal urinates or defecates. In the large animal industry, and particularly in the horse industry, the convention is to use the terms bedding and animal bedding rather than litter and animal litter. This may be because the large animals often sleep in the area in which the animal litter is placed. Despite the difference in term usage in different industries, to simplify use for the purposes of this disclosure which relates to animal litter and bedding for animals of all sizes, the term “bedding” is intended to encompass “litter”, and “bedding” may be used interchangeably with “litter.” A second aspect of the present invention relates to removing germs such as bacteria, viruses, fungi and other microbal contaminants from animal bedding by exposing the bedding to a disinfectant source such as heat, steam, ozone, chemical disinfectants, ultraviolet energy, gamma and/or microwave energy, cleaners and the like.

In a first embodiment of the invention, a blower for producing a fluid stream from a cleaning system and a vacuum for producing a fluid stream into the cleaning system are used simultaneously. The blower is configured to blow a first fluid stream, such as an air stream, toward an animal bedding target to be cleaned with enough force to raise the animal bedding from the surface on which it lays into temporary suspension in the first fluid stream. The vacuum is configured to simultaneously draw a second fluid stream into the cleaning system from the region of the target material with enough force to draw the material in and around the animal bedding, which is lighter than the animal bedding, from the fluid stream in which the animal bedding is temporarily suspended. The second fluid stream may then be filtered, for example with a cleanable cloth bag filter, HEAP filter, bacteria eliminating filter, or other microbal pathogen eliminating filter, to remove any contaminants from the second fluid stream. Specific embodiments relating to the first embodiment of the invention may include a fluid stream deflection plate or other enclosed shroud to control contamination being blown away to the surrounding environment by the blower fluid stream. In accordance with the second aspect of the invention, a disinfectant source is provided at or near the target material and directed toward the suspended animal bedding to destroy germs.

In a second embodiment of the invention, a vacuum for producing a fluid stream into a cleaning system is used to draw a stream of animal bedding and contaminants from an animal stall, or other area to be cleaned, into the cleaning system. The fluid stream is then drawn through a separation chamber, such as a cyclonic or other separator, to separate the relatively heavier animal bedding from relatively lighter contaminants. The animal bedding is then returned to the stall from which it was removed, or is stored until cleaning is complete and then returned to the stall. The contaminants are drawn away from the animal bedding and are filtered from suspension in the fluid stream. Specific embodiments relating to the second embodiment of the invention include a separation chamber configured with one or more straps for a user to carry, configured with wheels for a user to roll between locations to be cleaned, and larger configurations to be carried on or behind a truck. In accordance with the second aspect of the invention, the stream of animal bedding is exposed to a disinfectant at some point within the system to destroy germs and disinfect the animal bedding.

In a third embodiment of the invention, mechanical agitation is used to throw the animal bedding against an impact plate to further shake contaminants loose or at least move the animal bedding off of the ground into a fluid stream. The fluid stream draws the lighter contaminants from among the heavier animal bedding material into a vacuum for disposal or further filtering, and the heavier animal bedding falls to the ground. In one particular example of the third embodiment, a rotor with agitating blades is used to throw the animal bedding against the impact plate within a shroud. In another particular example, a conveyor moves the contaminated animal bedding into a fluid stream which blows fluid, such as air, through the animal bedding as it falls to the ground. A vacuum draws the contaminants from the fluid stream and leaves the animal bedding to return to the ground. Additional filtering of contaminants may be performed in the vacuum such as separation of contaminants from the fluid stream to create an uncontaminated fluid stream for reuse or to return to the environment, and separation of different categories of contaminants, for example, light and heavy contaminants. The first and second embodiments may also be enhanced by forms of mechanical moving or agitation of the animal bedding prior to cleaning in the fluid stream.

In fourth, fifth and sixth embodiments of the invention mechanical agitation is used to at least partially separate contaminants from the animal bedding prior to drawing the contaminants away in the fluid stream. There are numerous embodiments and examples which combine the mechanical agitation with the air separation. Some of these include single and double agitators to increase separation, shredding tines and rotor blades, and mechanical rollers and conveyors. The air stream may draw contaminants and/or animal bedding for further separation and may generate the air stream from numerous different locations adjacent a turbulence zone.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a side view of an animal bedding cleaning system configured according to the first embodiment of the present invention;

FIG. 2 is a side view of an animal bedding cleaning system with a fluid stream deflection plate configured according to the first embodiment of the present invention;

FIG. 3 is a perspective view of the deflection plate of the embodiment of FIG. 2;

FIG. 4 is a perspective view of an enclosed shroud for use in restricting blow-away contaminants according to an embodiment of the invention;

FIG. 5 is a side view of the air stream nozzles of the first embodiment of the invention illustrating how they separate the animal bedding from the contaminants;

FIGS. 6a and 6b are side views of configurations of the air stream nozzles of the first embodiment of the invention with the blower nozzle angled and a deflection plate included to enhance separation of the contaminants from the animal bedding;

FIG. 7 is a side view of the air stream nozzles of the first embodiment of the invention illustrating air flow within an enclosed shroud;

FIG. 8 is a view of the second embodiment of the invention including a cyclonic separation chamber;

FIG. 9 is a side view of a more complex embodiment of the invention with multiple separation process levels;

FIG. 10 is a perspective view of the third embodiment of the invention including mechanical separation of contaminants with air separation;

FIG. 11 is a cross-sectional view of the mechanical separator and shroud of FIG. 10 illustrating separation of contaminants from the animal bedding;

FIG. 12 is a cross-sectional view of a fourth embodiment of the invention including mechanical separator and shroud, similar to the view of FIG. 11 but having a funnel-shaped shroud;

FIG. 13 is a cross-sectional view of a particular embodiment of the mechanical separator portion comprising two agitators;

FIG. 14 is top view of a particular embodiment of the mechanical separator portion comprising a rotor with tines and interlaced shredding tines;

FIGS. 15a-c are views of mechanical agitator embodiments of the present invention;

FIG. 16 is a front view of a mechanical separation portion of a fifth embodiment of the invention with a portion of the shroud cut-away to show the mechanical agitators; and

FIG. 17 is a cross-sectional side view of a sixth embodiment of the invention comprising rollers and a front scoop.

### DETAILED DESCRIPTION OF EMBODIMENTS OF THE INVENTION

As discussed above, embodiments of the present invention relate to a cleaning system for removing contaminants from animal bedding. As used herein, contaminants are specifically intended to include such materials as dust, dirt, sand, hay, feed, hair, fur, dander, dust mites and other small pests, proteins from decomposing animal feces, pollen, mold spores, germs, other debris which is typically wind-blown, other common allergens and risks for respiratory infections and diseases, and the like (hereinafter “contaminants”). As used herein, germs are specifically intended to include living microbal contaminants such as bacteria, viruses, fungi, and the like (hereinafter “germs”). Through the use of embodiments of the present invention, contaminants may be removed from animal bedding to protect the animal and to extend the useable life of the bedding.

The invention is particularly useful in cleaning and disinfecting horse stalls to separate the horse bedding from the contaminants and pathogens that collect in the horse bedding over time and present health risks to the horse, and return the horse bedding for continued use. Embodiments of the invention prolong the usefulness of the horse bedding, promote a healthy environment for the horse, and reduce the overall maintenance and health care costs for the horse.

However, it will be understood by those of ordinary skill in the art that the invention is not limited to uses relating to horses and horse stalls, or for that matter trailers, barns, corrals, arenas, racetracks, and the like. Rather, any description relating to horses and the like is for the exemplary purposes of this disclosure, and those of ordinary skill in the art will also understand that the invention may also be used in a variety of applications with similar results for a variety of animals, such as in stalls, cages, kennels, trailers, racetracks, arenas, and the like of animals including, among others: animals such as cats, dogs (including racing dogs like greyhounds), gerbils, guinea pigs, mice, rats, hamsters, rabbits, ferrets, and skunks; laboratory animals; farm animals, such as chickens, goats, sheep, cows, elk, and deer; and zoo animals.

Moreover, it will be understood by those of ordinary skill in the art that the invention is not limited to the specific bedding and implementing components disclosed herein, as virtually any bedding and implementing components known in the art consistent with the intended operation of a method and/or system of the invention for cleaning and disinfecting animal stalls and associated animal bedding may be utilized. Accordingly, for example, although particular bedding and cleaning and disinfecting methods, mediums, systems, devices, covers, drying devices, heating devices, torching devices, irradiating devices, applicators, canisters, venting systems, control devices, sensors, and other implementing components are disclosed, such bedding and components may comprise any shape, size, style, type, model, version, measurement, concentration, material, and/or the like as is known in the art for such bedding and components consistent with the intended operation of a method and/or system of the invention for cleaning and disinfecting animal stalls and associated animal bedding. It will also be understood by those of ordinary skill in the art that the invention is not limited to use of any specific bedding or implementing components, provided that the bedding and components selected are consistent with the intended operation of a method and/or system of the invention for disinfecting animal stalls and associated animal bedding.

As used herein, “stall” refers to any structure that is configured to confine an animal in any manner for any amount of time such as stalls, portable stalls, trailers, barns, corrals, stables, arenas, racetracks, cages, pens, kennels, housings, boxes, litter boxes, and the like.

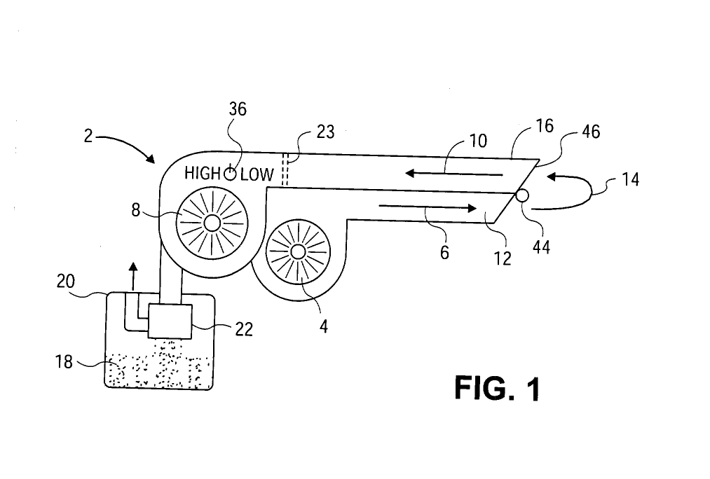

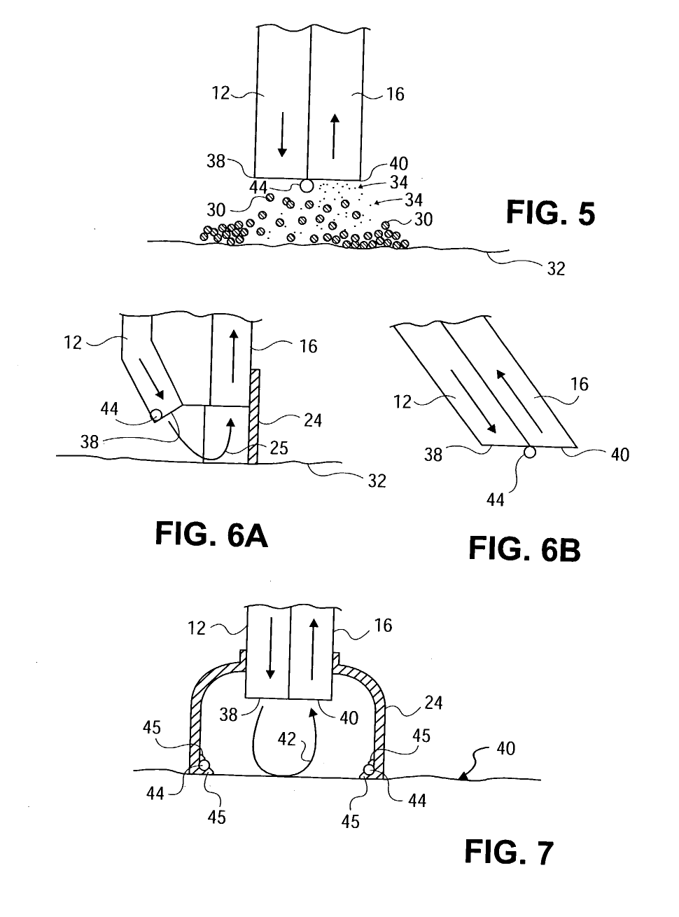

FIG. 1 illustrates a first embodiment of the cleaning system 2 of the invention which includes a blower motor 4 producing a first fluid stream in the direction of first arrow 6, and a vacuum motor 8 producing a second fluid stream in the direction of second arrow 10. When the first fluid stream exits the blower nozzle 12 and comes in contact with a contaminated animal bedding (see FIG. 5), at least a portion of the first fluid stream joins the second fluid stream, traveling in the direction of third arrow 14, carrying contaminants from the animal bedding into the vacuum nozzle 16 in the direction of the second arrow 10. The vacuum nozzle 16 carries the contaminants 18 to a storage bag 20.

In a particular configuration, the storage bag 20 is a cleanable cloth storage bag which filters the contaminants from the second fluid stream by passing the second fluid stream through one or more walls of the cloth storage bag. Alternatively or additionally, a bio filter, HEAP filter, reverse pulse filter or other filter that captures and/or eliminates pathogens from an air stream may be used to disinfect the released air stream. Additionally, the storage bag 20 may include one or more separation devices 22 to separate the contaminants 18 from the fluid stream. Appropriate separation devices 22 to clean an air stream of contaminants are well known in the art and are commonly used with vacuum products. Examples of air separation devices 22 include, but are not limited to, mesh filters, water filters, reverse pulse filters and bubblers, cyclonic separators, and the like. An additional filter 23 and/or blade may be included in line with the vacuum nozzle 16 to filter any animal bedding inadvertently drawn into the air stream and/or to chop up larger contaminants such as hay or animal hair drawn into the fluid stream. An optional high frequency energy source such as a microwave energy source, gamma wave energy source, ultraviolet light or other disinfecting medium dispenser 44, as explained further in reference to FIGS. 5-7, may optionally be included near the distal end 46 of the nozzles to destroy germs on and around the animal bedding. As used herein, the term “germicidal light” is intended to include any high frequency energy source; including, but not limited to microwave, gamma and ultraviolet frequency ranges.

Alternatively, other forms of disinfection may be included such as the use of cleansers, heat, steam, a controlled environment within a holding tank for the vacuum system in which aerobic and/or anaerobic environments are maintained for a predetermined time to destroy pathogens, and the like. Such forms of disinfection are discussed and disclosed in Applicant's co-pending patent application to William Opfel entitled “METHODS AND SYSTEMS FOR DISINFECTING ANIMAL LITTER AND STALLS,” Ser. No. ______, filed ______, the disclosure of which is hereby incorporated herein by reference. Such disinfection methods may be applied separate from, or incorporated into, the cleaning systems of the present invention by spray, radiation, environmental application, or other methods which will be clear to those of ordinary skill in the art from the combined disclosures of the present application and the copending application. The motors 4 and 8 may be powered by any power source known in the art. Examples of conventional power sources include gas and electric.

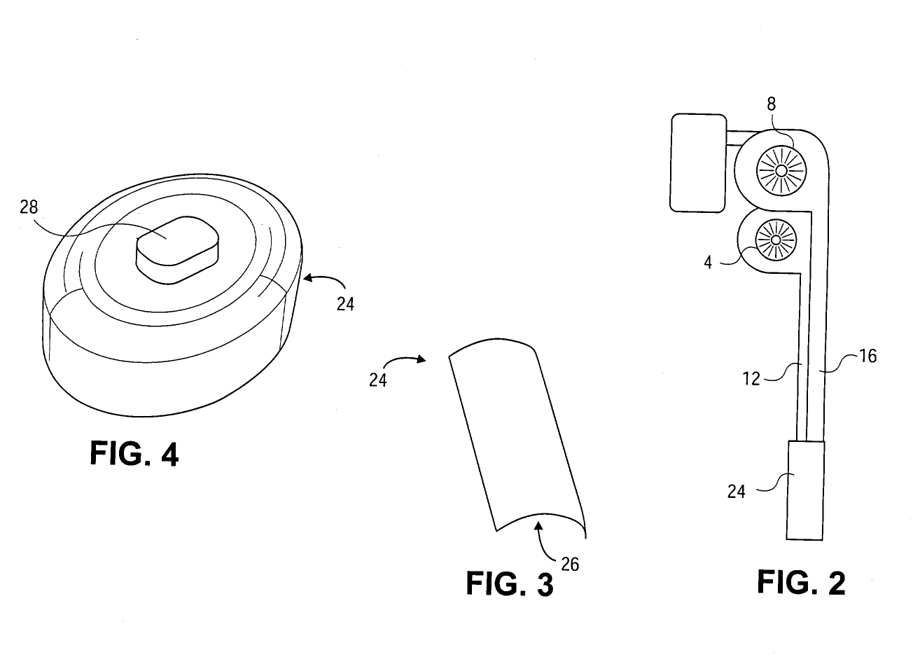

FIG. 2 illustrates the first embodiment of the invention having a blower motor 4 blowing a first fluid stream through the blower nozzle 12 and a vacuum motor 8 drawing a second fluid stream through the vacuum nozzle 16, but also including a shroud 24 configured as a deflector plate at least partially surrounding the distal opening to the vacuum nozzle 16. The shroud 24 may be of any shape configured to encourage air flow toward the vacuum nozzle 16 opening. The shroud 24 may, as shown in FIG. 2, also extend at least partially around the distal opening to the blower nozzle 12 to further encourage air flow to the vacuum nozzle 16. FIGS. 3 and 4 illustrate two exemplary embodiments of shrouds 24 for use with the invention.

The first exemplary embodiment of the shroud 24 shown in FIG. 3 is an arcuate embodiment which fits over the vacuum nozzle 16, extending beyond it. The shroud 24, if formed separate from the vacuum nozzle 16, may be attached to the vacuum nozzle 16 with an internal surface 26 of the shroud 24 which either closely resembles the arcuate shape of the vacuum nozzle 16 or which is bendable to form to the shape of the vacuum nozzle 16 is against the vacuum nozzle. The shroud 24 in such a configuration could be coupled to the vacuum nozzle 16 with an adhesive, straps, screws, by molding the shroud 24 to tightly fit over the vacuum nozzle 16 and be held in place by friction, or by any other means known in the art for coupling the materials of which the vacuum nozzle 16 and shroud 24 are made. Alternatively, the shroud 24 may be formed as part of the vacuum nozzle 16, the blower nozzle 12 or, in particular configurations, both the vacuum nozzle 16 and the blower nozzle 12. It is contemplated that the vacuum nozzle 16, the blower nozzle 12 and the shroud 24 may be formed, for example, of a plastic, a nylon, a metal, or a mixture thereof. Methods of forming and molding plastics and metals are well known in the art.

The second exemplary embodiment of the shroud 24 shown in FIG. 4 is a partially enclosed embodiment which includes an angled opening 28 in the top for receiving both the vacuum nozzle 16 and the blower nozzle 12 therethrough. The shroud 24 opening 28, like the arcuate deflection plate shroud 24, may be coupled to the vacuum nozzle 16 and blower nozzle 12 by any known methods, or may alternatively be formed as part of the blower and vacuum nozzles 12 and 16. The bottom of the shroud 24 is open and provides access to the animal bedding (see FIG. 7). Use of an enclosed shroud 24 reduces the likelihood that contaminants will be blown into the air or to surrounding areas when the animal bedding is being cleaned.

FIG. 5 illustrates the use and operation of the first embodiment of the cleaning system with a germicidal light. As with previous embodiments, other disinfecting methods may alternatively be employed as described with reference to FIG. 1. A fluid, such as air, is blown from the blower nozzle 12 into animal bedding 30 to be cleaned. The blown air is of sufficient force to lift the animal bedding 30 from a surface 32, and allow the bedding 30 and contaminants 34 to be suspended above the surface 32 within a turbulence zone. The exact blowing power of the blower nozzle 12 needed depends, among other factors, upon the weight of the animal bedding 30 and the distance of the blower and/or vacuum nozzles from the ground. Although other blower power applications are certainly contemplated for various weights of animal bedding, for a hand-held model, a 1-2 horsepower (HP) blower motor appears to work well for an animal bedding having a granule size of approximately 4-20 mesh and an animal bedding density of approximately 20-70 lbs/ft³. An appropriate animal bedding and horse bedding having these properties may be obtained through Equidry Bedding Products, LLC of Arizona. It is contemplated that the cleaning system may be used on animal bedding having a density even as high as 150 lbs/ft³ or more. For particular bedding densities, mesh sizes and weights, other power level configurations, or even adjustable power blowers may also be used. For example, FIG. 1 shows an optional blowing/vacuuming power adjuster knob 36 to adjust the blowing and/or vacuum power between a low power and a high power. For applications where lesser or greater quantities or weights of materials need to be cleaned at one time, lesser or greater vacuum and/or blower powers may be used.

A disinfecting medium dispenser 44, such as that described with reference to FIG. 1, may be included near the distal end of the cleaning system so that at least the animal bedding 30 and perhaps also the contaminants 34 are exposed to disinfecting medium emitted from the dispenser 44 when the animal bedding 30 is suspended above the surface. In one particular embodiment, a germicidal lights, for example, from Atlantic Ultraviolet Corporation of Hauppauge, N.Y. for use in air duct disinfection systems, is used and may readily be adapted by one of ordinary skill in the art for use with embodiments of the present invention. Atlantic Ultraviolet Corporation has found that by emitting ultraviolet energy toward a surface, a large majority of the energy having a wavelength which is at the mercury resonance line of 254 nanometers, germs such as virus, bacteria and mold spores can be destroyed with as high as 98% effectiveness on surfaces which are contacted by the irradiating light. Alternatively, a disinfectant spray may be used, a heat source, such as irradiated or steam heat may be used, or alternate forms of disinfection are available. By exposing the animal bedding 30 to a disinfecting medium while it is suspended above the surface, more of each animal bedding 30 granule spinning due to turbulence will be exposed to the medium, more germs will be destroyed, and the animal bedding will be cleaner. For embodiments where it is desirable to control the distribution of the disinfecting medium, directional baffles or containment shields (FIG. 7) may be used.

A fluid stream including air and contaminants 34 is drawn into the vacuum nozzle 16 to separate the animal bedding 30 from the contaminants 34 by gravity separation. The vacuum power is of sufficient force to draw the contaminants 34 into the vacuum nozzle 16, but of a force insufficient to draw any appreciable amount of animal bedding 30 into the vacuum nozzle 16. The exact vacuum power of the blower nozzle 12 depends upon the weight of the animal bedding 30 and the weight of the contaminants 34 to be cleaned from the animal bedding 30. Although other vacuum power applications are certainly contemplated for various weights of animal bedding, for a hand-held model, a 1-2 HP vacuum motor appears to work well for the animal bedding described above having a granule size of approximately 4-20 mesh and an animal bedding density of approximately 20-70 lbs/ft³, though greater densities are contemplated. For particular bedding densities, mesh sizes and weights, other power level configurations, or even adjustable power vacuums may also be used. For applications where greater quantities or weights of materials need to be cleaned at one time, greater vacuum and/or blower powers may be used.

Due to the difference in the respective weights and densities of the animal bedding 30 and the contaminants 34, after the blower causes the animal bedding 30 and the contaminants 34 to be lifted from the surface 32 and be mixed with the fluid flow from the blower nozzle 12 to the vacuum nozzle 16, the contaminants 34 are drawn by the fluid flow and the animal bedding 30 drops to the surface 32. Some manual adjustment may also be made by moving the distal ends 38 and 40 of the blower and vacuum nozzles 12 and 16 nearer to and farther away from the animal bedding 30 and contaminants 34. As the distal ends 38 and 40 move nearer to the materials 30 and 34, the effect of the blower and vacuum on the materials 30 and 34 is increased. As the distal ends 38 and 40 are moved farther away from the materials, the effect is decreased. In this way, a user of the cleaning system can adjust to and find an optimal blowing and vacuum power for the particular animal bedding and contaminants used, in part, by adjusting the distance of the nozzle end from the animal bedding. Particular embodiments of the invention may also include an adjustable shroud to assist a user in gauging how far away the nozzle end should be for particular grades or classifications of animal bedding. For example, a shroud setting which extends the shroud 12 inches from the nozzle end may be appropriate for animal bedding having a size between 14-30 mesh, while a setting which extends the shroud only 8 inches from the nozzle end may be appropriate for the heavier animal bedding having a size between 4-20 mesh. The desired settings may also be affected by the angle at which a user holds the system with respect to the ground. Because of the many possible combinations, each user may need to adjust the shroud as suits the user for the particular animal bedding to be cleaned and the user's personal cleaning style.

FIGS. 6a and 6b illustrate embodiments of the invention comprising a blower nozzle 16 angled to increase the disruption of the animal bedding by the blowing fluid stream. In FIG. 6a, a cut-away of a shroud 24 illustrates that the shroud 24 further enhances the collection of dust and other allergens from the animal bedding. In FIG. 6a, the blower nozzle 12 is directed to blow into the animal bedding at an angle other than parallel to the vacuum nozzle. This may allow the blown fluid stream to better lift the animal bedding and contaminants, and direct the contaminants into the fluid stream, and may also result in some cyclonic spinning of the materials in the direction of arrow 25 to enhance separation within the turbulence zone. In FIG. 6b, both the blower and vacuum nozzles 12 and 16 are formed so that when the distal ends 38 and 40 are placed parallel to the ground, the blower and vacuum nozzles 12 and 16 are at an angle other than perpendicular to the ground (shown in FIG. 6b as approximately 45°). A disinfecting medium dispenser 44 is also shown just inside the distal end 38 of the blower nozzle 12 directing the disinfecting medium therefrom toward the surface 32 and the shroud 24. This will assist in focusing the medium on the target area to limit and preventing outside exposure to the disinfecting medium. This is particularly advantageous for use with high frequency energy from a germicidal light, or where heat or chemicals are used.

FIG. 7 illustrates an enclosed shroud 24 configuration. The arrow 42 from the blower nozzle 12 to the vacuum nozzle 16 represents the fluid stream flow within the shroud 24. Without an enclosure about the area around the nozzle ends 38 and 40, some contaminants may be blown away from the vacuum nozzle end 40 rather than being suspended in the fluid stream and drawn into the vacuum nozzle 16. Materials which are blown away may contaminate the air or other regions which have already been cleaned. By placing an enclosed shroud 24 around the area, it is much less likely that contaminants will be blown away from the vacuum nozzle 16. Additionally, the use of an enclosed shroud 24 enhances the effectiveness of the blower and vacuum by containing the turbulence zone therein. Because the respective energies of the blower and vacuum are focused within the limited volume of the enclosed shroud 24, separation effectiveness is increased. As a result, lower blower air volumes and vacuum pressures may be used than without an enclosed shroud.

It will be clear to those of ordinary skill in the art that the lower opening of the enclosed shroud may be of any shape and volume to contain the turbulence region and enhance separation of contaminants from the bedding, such as, for example, rounded, oval, rectangular, square, and the like. While the upper region of embodiments shown in FIGS. 4 and 7 illustrate a domed upper region, it will be understood that any shape may be used such as, for example, boxed, conical and pyramidal. The dimensions of the lower opening of the enclosed shroud 24 may be of any dimensional size which is larger than the combined dimensional opening size of the openings for the blower and vacuum nozzles. However, a size of approximately 2 to 20 times larger is desirable to maximally enhance the turbulence region. For example, if the combined openings dimensions are 3″×6″, an enclosure opening of between 6″×12″ to 21″×42″ may be desired, though proportional enlargements are not required or necessarily desirable. More particularly, a dimensional size between approximately 3 to 10 times that of the combined nozzle openings provides an easily maneuverable unit with an adequate turbulence region. The specific shape, dimensions and volume of an optimal turbulence region within the enclosed shroud will depend upon the vacuum and blower powers, the distance of the nozzle openings from the ground, the weight and size of the animal bedding, and the angle and location at which the blower nozzle enters the shroud. One of ordinary skill in the art will readily be able to determine an appropriate shape, dimensions and volume for a shroud of a particular cleaning system without undue experimentation from the explanation provided herein.

The connection between the enclosed shroud 24 and the blower and vacuum nozzles 12 and 16 may further be made adjustable to allow the distance between the distal ends 38 and 40 of the nozzles and the animal bedding 44 to be adjusted depending, among other factors, upon the power of the vacuum and blower, and the weight and/or density of the animal bedding to be cleaned.

One or more disinfecting medium dispensers 44 may also be included within the shroud 24 to destroy germs on and among the animal bedding within the shroud. By placing the dispensers 44 within the shroud 24, and perhaps by even including direction and protection plates 45, the exposure regions for disinfecting medium may be more limited to specific regions within the shroud 24. A coating may optionally be placed on the inner surface of the shroud 24 or on portions of the dispenser 44 to absorb high frequency energy contacting the surface in embodiments where germicidal lights are used to prevent reflection to areas outside the shroud 24 or to direct the energy emitting from the dispensers 44.

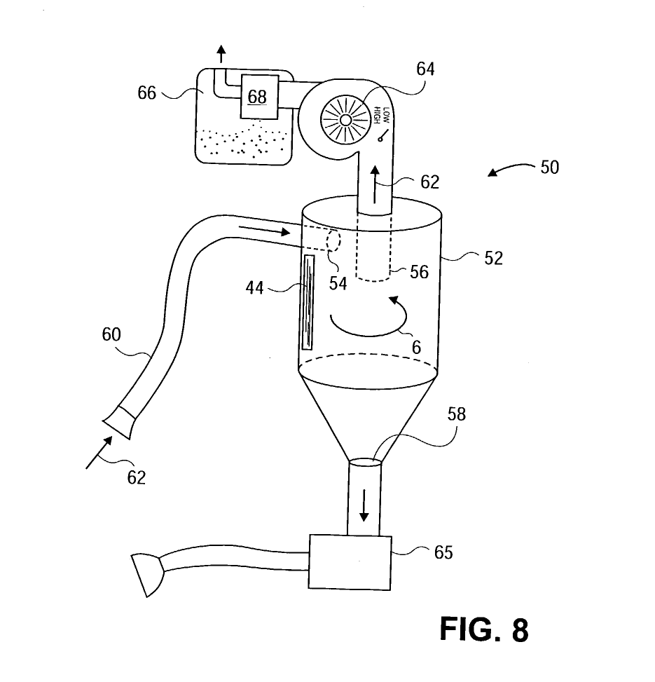

FIG. 8 illustrates a configuration of a second embodiment of the cleaning system 50 of the present invention including a cyclonic separator to separate the animal bedding from the contaminants. The cyclonic separator creates an air turbulence region within the separator for separation of the contaminants from the animal bedding. Cyclonic separators for use with vacuum cleaners are well known in the art. Examples of particular patents which describe the general nature and operation of cyclonic separation, particularly for its use in a household vacuum cleaner include: U.S. Pat. No. 6,350,292 to Lee et al. (issued Feb. 26, 2002), U.S. Pat. No. 6,344,064 to Conrad (issued Feb. 5, 2002), and U.S. Pat. No. 6,261,330 to Dyson et al. (issued Jul. 17, 2001), the disclosures of which are hereby incorporated herein by reference. Cyclonic separation used in a vacuum cleaner, however, is designed to separate dust and allergens from an air stream for disposal of the dust and allergens and release of a filtered air stream to the environment. Conventional vacuum cleaners are not designed to remove contaminants from loose granular materials.

Configurations of this second embodiment of the present invention include a cyclonic separator 52 which has a fluid stream inlet 54, a fluid stream outlet 56 and an animal bedding outlet 58. Using the basic principles of cyclonic separation, a fluid stream, which comprises both relatively light contaminants and relatively heavy animal bedding is drawn into the cyclonic separator 52 through a vacuum hose 60 in the direction of arrow 62. The vacuum hose 60 leads to the cyclonic separator 52 and enters the separator 52 near a wall of the separator 52. The fluid stream initially flows around the fluid stream outlet 56 of the cyclonic separator 52 in the direction of arrow 65. The animal bedding is separated from the contaminants by cyclonic separation (also called centrifugation in the art). The animal bedding granules are forced closer to the walls of the cyclonic separator 52, and the contaminants are forced toward the axial center of the cyclonic separator 52. The contaminants which move closer to the axial center of the cyclonic separator 52 are drawn into the outlet 56 in the direction of fluid stream arrow 63 by the vacuum created there by vacuum motor 64.

The vacuum motor 64 provides enough vacuum to draw the animal bedding through the vacuum tube 60 to centrifugally separate the animal bedding from intermixed contaminants within the cyclonic separator 52. Alternatively, a blower motor could be provided in line with vacuum tube 60. The precise power of the vacuum/blower motor depends upon the weight and/or density of the animal bedding and contaminants, but may be readily calculated by those of ordinary skill in the art. The vacuum motor 64 passes the fluid stream into a collection bag 66. To clean the air passing from the collection bag, additional filtering may be performed by an additional filter 68. The additional filter 68 may be placed prior to or after the vacuum motor 64 and may be of any variety known in the art, including, but not limited to, those filters commonly used in the vacuum art to remove dust and dirt such as mesh filters, cyclonic filters, water bubbling filters, and the like. The clean animal bedding drops to the bottom of the cyclonic separator 52 and exits the cyclonic separator 52 through the animal bedding outlet 58. As the animal bedding continues cyclonic rotations around the separator housing toward the bottom of the housing where it narrows, there is further separation due to the reduced radius of rotation.

An airlock valve 67, such as a simple rubber boot or a burp valve, is used to maintain pressure within the cyclonic separator 52. More complex embodiments may include passive or active systems for maintaining the vacuum pressure within the chamber while permitting the animal bedding to pass from the cyclonic separator 52. An optional blower motor 69 is further included to force the animal bedding through the output nozzle. The blower motor 69 is particularly helpful in embodiments where the cyclonic separator 52 is not positioned near the area being cleaned. The clean animal bedding may be returned to the area from which it was removed, or may alternatively be stored for a time to allow for additional cleaning of the area before the animal bedding is returned.

For example, to clean a horse stall using a configuration of this second embodiment of the invention, the vacuum motor 64 is turned on and draws a fluid stream through the vacuum hose 60. The vacuum hose 60, with the vacuum applied, draws the horse bedding, for example that manufactured by Equidry Bedding Products, LLC of Arizona, having an approximate density of between 20-70 lb/ft³, from the horse stall into the cyclonic separator 52 along with all of the intermixed contaminants. The heavy horse bedding is separated from the relatively light contaminants by the separator 52. The light contaminants are drawn through the outlet 56, and stored for disposal. The heavy horse bedding may be placed back into the stall after it is clean, or may be placed into the stall simultaneous with cleaning other parts of the stall. A blower motor 65 is included near the outlet 58 to maintain the necessary vacuum pressure within the separator 52 and to assist the animal bedding in moving back to the stall.

It should be noted that many animal bedding are not hard enough to withstand a cyclonic separation process and would be broken up and otherwise degraded by it. Those of ordinary skill in the art will understand and be able to determine the hardness required based upon the particular cyclonic separator and vacuum and blower pressures used. The horse bedding products available through Equidry Bedding Products, LLC of Arizona (“Equidry”) typically have a hardness rating based upon a LA Abrasion test value of less than 40 (and more particularly less than 30) using modified mesh sizes for the smaller granule size of horse bedding, and are sufficiently hard to withstand a cyclonic separator process. Increasing hardness, however, may significantly reduce the absorptive capacity and rate of the animal bedding in undesirable ways. Those of ordinary skill in the art will understand the benefits and trade-off of hardness and absorbency in animal bedding.

Particularly useful animal bedding for use with the present invention are those having an absorption capacity of approximately 0.5 ml/g to approximately 2.5 ml/g, or more specifically approximately 1.4 ml/g to approximately 1.9 ml/g. High absorbency is achieved as a result of porosity enhancing techniques and the resulting microporosity and macroporosity of the animal bedding granules. The combination of external surface area and internal porosity surface areas can lead to very large lab-calculated surface areas. Animal bedding compositions particularly useful with the invention may have a surface area of approximately 2,000,000 ft²/ft³ to approximately 40,000,000 ft²/ft³, or even up to approximately 75,000,000 ft²/ft³ if acid activated or additionally bloated by kilning. Examples of approximate surface areas of gravel, sand, diatomaceous earth, and Equidry animal bedding are illustrated in the following table for comparison:

| | | Diatomaceous | Equidry |
|---|---|---|---|
| Gravel | Sand | Earth | Animal Bedding |
| 600 ft²/ft³ | 1500 ft²/ft³ | 200,000 ft²/ft³ | 2,000,000-75,000,000 ft²/ft³ |

An absorbency rate is a measure of the speed of movement of water (water front) as it is absorbed into a material. A wicking test was performed on two samples of Equidry animal bedding by allowing water from a water bath to climb the animal bedding composition in a standard, plastic, 52 mm inside diameter, 500 ml, graduated PolyLab™ cylinder, or column as is known in the art. Water enters the column through perforations in the base of the column. The perforations are of sufficient size and number to allow water from the bath to enter in the column, but not allow material to fall into the water bath. The wetting front in the material rises over time and is then plotted as distance versus time. A first animal bedding sample having granule sizes ranging from between 8 mesh to 20 mesh had an absorbancy rate of approximately 90 milliliters or more within 10 minutes. A second animal bedding sample having granule sizes ranging from between 20 mesh to 50 mesh had an absorbancy rate of approximately 105 milliliters or more within 90 seconds.

Accordingly, animal bedding with superior absorbency and wicking, and sufficient hardness to not become significantly crushed during the cleaning process are most desirable for use with embodiments of the present invention. If the animal bedding is too soft, it will become broken and turned to powder from mechanical agitation or impact with other animal bedding or surfaces within the turbulence zone. If the animal bedding lacks absorption capacity or absorbs too slowly, it is less useful as animal bedding.

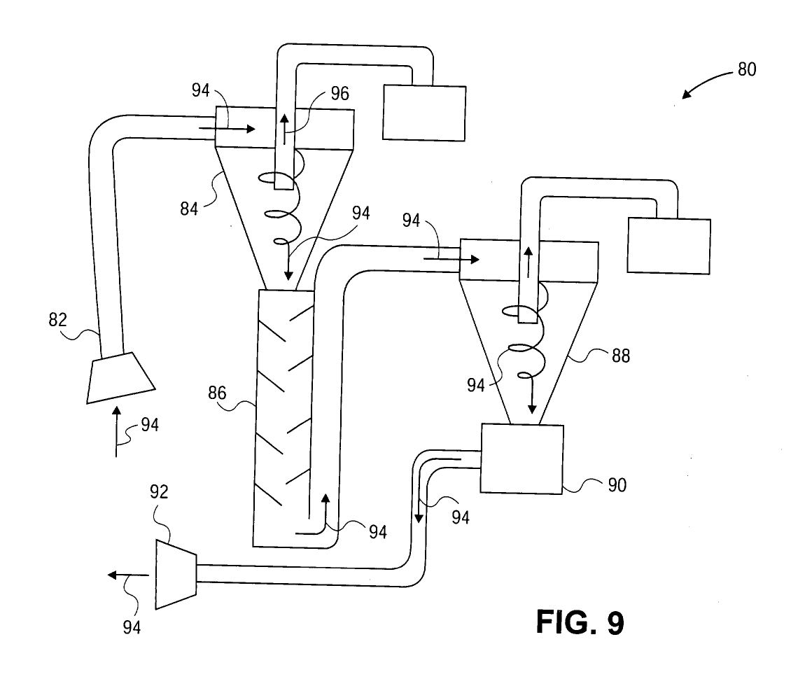

FIG. 9 illustrates a more complex embodiment of an animal bedding cleaning system 80 having multiple separation levels for more fully cleaning contaminants and germs from animal bedding. This particular embodiment includes an intake nozzle 82, a first cyclonic separator 84, an air aspirator 86, a second cyclonic separator 88, a blower 90 and an output nozzle 92. Animal bedding travels through the system in the direction of arrows 94. In each separator or aspirator, additional separation of contaminants from the animal bedding is obtained. The operation of cyclonic separators 84 and 88 is similar to and has been described with relation to previous separator embodiments. For the air aspirator 86, at the end of each baffle, where the ends of the baffles cross, is an air turbulence area to assist in separation of contaminants from the animal bedding traveling through the turbulence area. In the region under each baffle additional turbulence occurs causing further separation. Contaminants separated from the animal bedding travel in the direction of arrows 96. Each cyclonic separator 88 includes its own vacuum/blower motor for drawing the animal bedding to be cleaned into the separator and separating the contaminants from the animal bedding.

In operation, the intake nozzle 82 is passed over and through animal bedding to be cleaned. The vacuum pressure associated with the system 80 is sufficient to draw the animal bedding into the first separator 84 which separates loose contaminants from the bedding before the bedding is passed down through the baffels of the gravity agitator 86 to ensure all contaminants are loosened. The animal bedding is then passed through the second separator 88 to remove any contaminants remaining in the animal bedding. The blower 90 is configured to produce a positive pressure sufficient to return the animal bedding to the location from which it was taken.

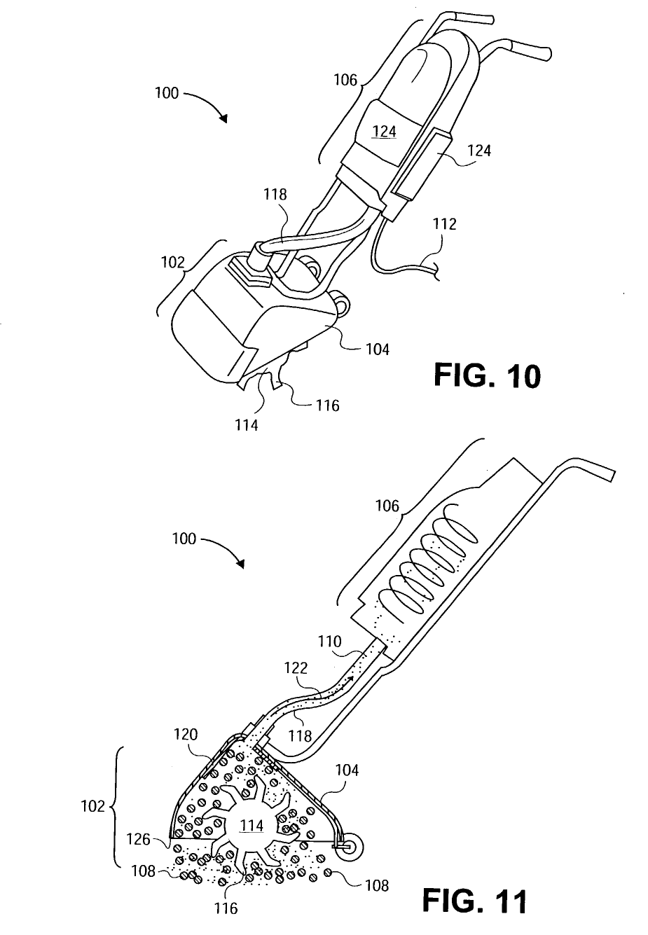

FIG. 10 is a perspective view of an animal bedding cleaning system 100 comprising a mechanical agitator 102 within a shroud 104 coupled to a vacuum 106. FIG. 11 is a cross-sectional view of the animal bedding cleaning system 100 of FIG. 10 illustrating the movement of the animal bedding 108 and contaminants 110. The animal bedding cleaning system 100 of the embodiment illustrated in FIGS. 10 and 11 is an electrically powered system, as indicated by the electric cord 112. However, gas- or propane-powered systems 100 are also contemplated as well as combination systems. For example, the vacuum 106 may be electrically powered and the mechanical agitation portion 102 may be gas powered.

The mechanical agitator portion 102 of the illustrated embodiment includes a rotor 114 having blades 116, also commonly called arms or tines in the art, which agitate the animal bedding 108. This agitation causes some separation of contaminants 110 from the animal bedding 108, and moves the animal bedding 108 into a fluid stream which flows from within the shroud 104, through the vacuum hose 118 to the vacuum 106. Depending upon the speed at which the rotor 114 and blades 116 are spinning, the animal bedding and contaminants 110 may be thrown toward impact plate 120 with a lesser or greater force. The impact place 120 is positioned and angled such that impact of the animal bedding 108 with the impact plate 120 causes additional separation of contaminants 110 from the animal bedding 108. In a particular embodiment, the rotor blades 116 spin about an axis substantially parallel to the impact plate 120 and the impact plate 120 is angled such that the animal bedding 108 being thrown at it impacts it substantially perpendicular to the plate 120. The impact plate 120 may be attached to the shroud 104 or other support or may form a portion of the shroud 104. Alternatively, the shroud 104 may act as an impact plate 120. It is important only that the contaminants and material to be clean which are thrown by the rotor blades 116 are stopped at a point near the air stream path so that the contaminants 110 can be drawn into the vacuum hose 118. Having a structure which is stationary with respect to the mechanical agitator 114 and which is in the path of the thrown animal bedding 108 helps to accomplish this purpose. It is contemplated that particular embodiments of the invention may not include a shroud 104 enclosing the turbulence zone, but will, nevertheless, include an impact plate 120.

The vacuum hose 118 enters the shroud 104 at a point near the impact plate 120, and in a particular embodiment parallel to the impact plate 120. Parallel entry is not crucial to the invention, but may increase the efficiency of contaminant removal. When the vacuum 106 is turned on, a fluid stream, indicated by arrow 122, draws air and contaminants 110 from within the shroud, and primarily from the area around the impact plate 120, through the vacuum hose 118 into the vacuum 106. A disinfecting medium, such as that shown and described with reference to the first and second embodiments herein, may also be used in accordance with the second aspect of the invention to disinfect the animal bedding as contaminants are removed. Alternatively, or additionally, the fluid stream may comprise a cleaning solution or antibacterial agent to further disinfect the animal bedding as the fluid stream removes contaminants.

The vacuum 106 may be any vacuum known in the art for creating a fluid stream. For example, those cyclonic vacuums manufactured and distributed by Dyson of the United Kingdom or Hoover or Ruwac of the United States are acceptable. Alternatively, the vacuum systems disclosed in relation with the first and second embodiments of the invention herein are sufficient. The vacuum shown in FIG. 11 is illustrated very simply as a canister through which a cyclonic air stream is created. However, those of ordinary skill in the art will understand that the vacuum obviously includes a source and structure for creating the cyclonic air stream and may include other filtering devices. As shown in FIG. 10, the vacuum may also include additional air filters 124 for further filtering of the contaminants from the air stream, or for dividing the contaminants into two or more categories of contaminants, such as by density or weight. Those of ordinary skill in the art will understand how to separate these contaminants into categories from the disclosure provided.

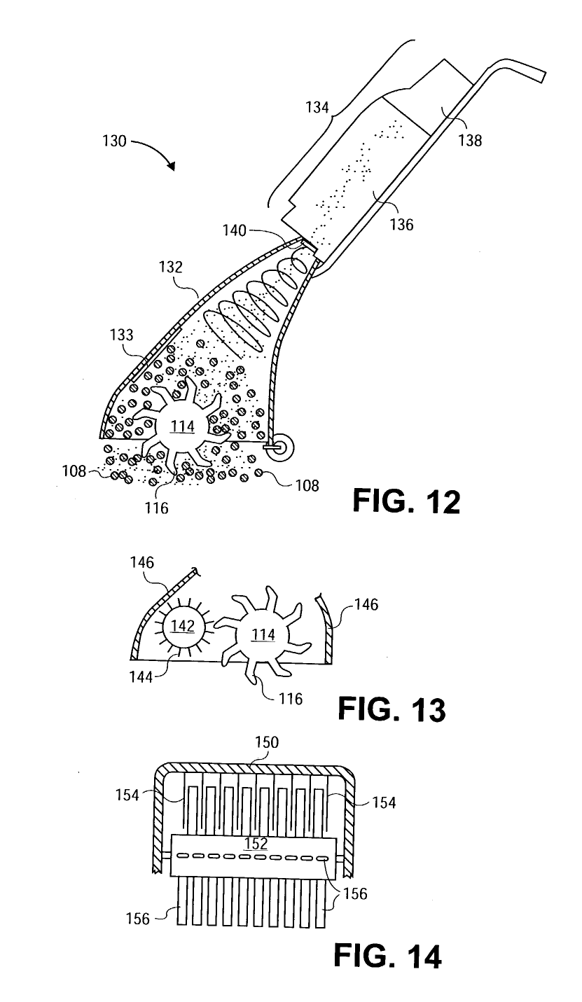

In a fourth embodiment of the invention, shown in FIG. 12, the animal bedding cleaning system 130 is much like the animal bedding cleaning system 100 shown in FIGS. 10 and 11, and many of the components are the same. However, the animal bedding cleaning system 130 includes a shroud 132 which is funnel-shaped to create a turbulence zone within the funnel as the air stream draws contaminants to the vacuum 134. It will be understood by those of ordinary skill in the art that the features used for the vacuum 134 of this embodiment may be interchanged with or added to features on the other vacuums shown and described with reference to other embodiments of the invention. The vacuum 134 shown in the embodiment of FIG. 12 includes a dust collection chamber 136 and a reverse pulse filter 138 as is well known in the art for filtering dust fines from an air stream. In some instances, an optional screen filter 140 may also be included between the shroud 132 and the dust collection chamber 136 to further screen larger materials from entering the dust collection chamber 136. Use of the optional screen filter 140 may depend upon the nature of the contaminants among the animal bedding 108. Where a majority of the contaminants are smaller than the animal bedding 108, the screen filter is advisable.

The cyclonic movement of the air stream within the shroud 132 and into the dust collection chamber 136 helps to separate contaminants from the animal bedding 108 as the rotor blades 116 of the mechanical agitator 114 throw the animal bedding 108 into the turbulence zone within the shroud 132. Additionally, as with the embodiment shown in FIG. 11, an impact plate 133 may be used to reinforce the shroud 132 where most of the animal bedding 108 would impact the shroud wall.

FIG. 13 illustrates a cross-sectional view of a mechanical agitator portion of an animal bedding cleaning system for use with the embodiment of FIGS. 11, 12 or 16. The mechanical agitator portion of this embodiment includes a first mechanical agitator 114 having rotor blades 116 and rotating at a first speed, and a second mechanical agitator 142 having rotor blades 144 and rotating at a second speed. Use of a second mechanical agitator 142 within the shroud 146 in addition to the first mechanical agitator 114 assists in the break-up of large contaminant pieces, such as manure and straw, and further assists in the separation of contaminants from the animal bedding 108. The second mechanical agitator 142 may be configured to rotate in either the same or opposite direction as the first mechanical agitator 114, and may be configured to rotate at the same or different speed as the first mechanical agitator 114. If the rotor blades 116 and 144 of the first and second mechanical agitators 114 and 142 respectively.

FIG. 14 illustrates a top view of a mechanical agitator portion of an animal bedding cleaning system with the shroud 150 cut away to show the mechanical agitator 152 and shredding tines 154. As with the mechanical agitator portion shown in FIG. 13, the mechanical agitator portion shown in FIG. 14 may also be used with the embodiments shown in FIGS. 11, 12 or 16. The mechanical agitator portion of this embodiment includes a mechanical agitator 152 having narrow rotor blades 156, and interspaced shredding tines 154 for breaking up larger contaminants. By having the rotor blades 156 pass through the stationary shredding tines 154, larger contaminants on the rotor blades 156 will be broken up and passed through the tines 154. The shredding tines may be extended from a wall of the shroud 150, or supported by a separate frame (not shown). Alternatively, similar to the embodiment shown in FIG. 13, the shredding tines 154 may be coupled to a mechanical agitator and caused to rotate in the same or different direction from the rotor blades 156, and at the same or a different speed than the rotor blades 156 are rotating.

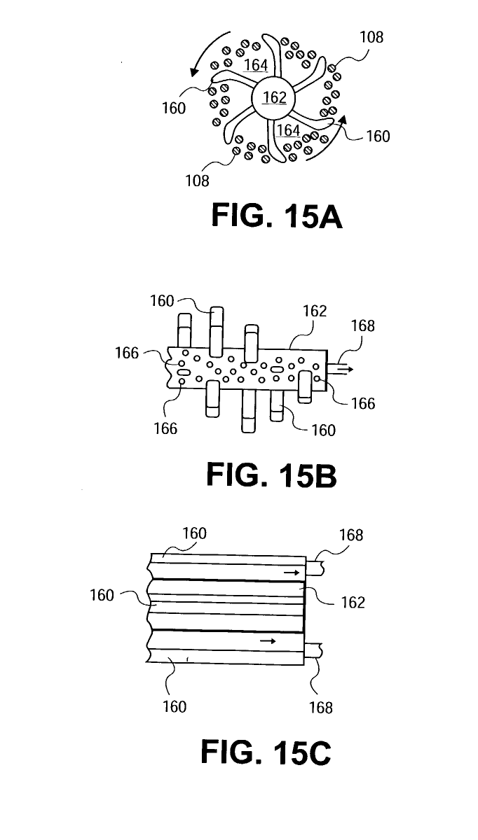

FIG. 15a illustrates an end view of another embodiment of a mechanical agitator for use with an embodiment of the present invention, such as those shown in FIGS. 11, 12 and 16. The present embodiment is used to illustrate an additional aspect of the present invention which results when the rotor blades 160 are spun at a fast enough rate to cause the animal bedding 108 to cyclone. Within the confined space of a shroud, if the mechanical agitator 162 is spun at a fast enough rate, the animal bedding 108 will, due to the centripetal force of the rotation, spin about the mechanical agitator body 162 and tend to conglomerate within a radial range from the agitator body 162 depending upon the particular weight of each animal bedding 108 particle, resulting in a gap 164 between the rotating animal bedding 108 and the agitator body 162. This will respond much like a cyclone tipped on its side. The operation and advantages of cyclones in separating materials was discussed with greater detail in reference to other embodiments of the present invention. In this cyclonic action, the lighter contaminants will tend to collect in the gap between the rotating animal bedding 108 and the agitator body 162. As with any of the mechanical agitator embodiments shown and described herein, the particular shape of the rotor blades is not crucial to the operation of the invention, though blades with angled tips may tend to maintain the animal bedding in cyclonic rotation more easily.

FIGS. 15b and 15c show two examples of a side view of the mechanical agitator of FIG. 15a, illustrating how contaminants may be drawn from the gap 164. FIG. 15b shows a first example of an agitator body 162 having a plurality of perforations 166 along the length of the agitator body 162. A vacuum hose 168 is attached to one or both ends of the agitator body with a swivel connection to draw air and contaminants from the gap 164 into the agitator body 162 and thereafter into the vacuum hose 168. By making the perforations smaller than the animal bedding 108, the small contaminants may be collected without drawing any animal bedding 108 into the vacuum hose 168. FIG. 15c shows a second example of an agitator body, but without perforations. Instead, one or more vacuum hoses 168 is placed at one or more ends of the mechanical agitator adjacent to the gap 164. The vacuum hoses 168 draw air and small contaminants from within the air gap into the vacuum hose 168. Additional screening, separation or filtering methods as described herein may be used to prevent animal bedding 108 from passing into the vacuum hose. It will be clear to those of ordinary skill in the art that the various rotor blades and tines of the present invention may be interchanged or used in other embodiments freely and that the particular shapes and types of rotor blades and tines shown are only for example and convenience of description. The vacuum, rotor blade and perforation examples shown with reference to FIGS. 15a-c, for example, may also be incorporated into the other embodiments shown herein.

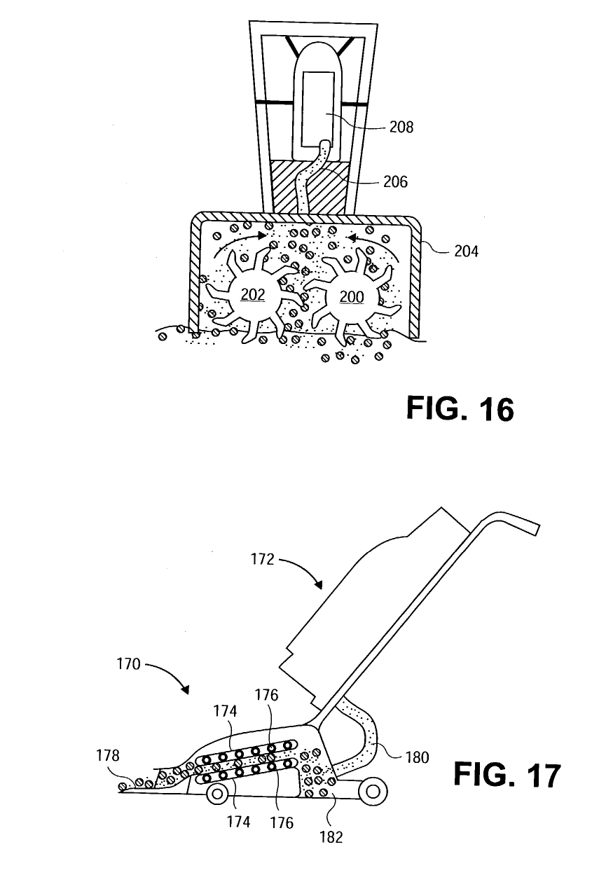

FIG. 16 illustrates a front view of a fifth embodiment of the invention with the shroud 204 cut away to show the mechanical agitators and their operation. The vacuum and filter components of this fifth embodiment are similar to those found in other embodiments of the present invention described herein. Each of two opposing rotors 200 and 202 throws animal bedding toward a center location within the shroud 204 whereat the animal bedding comes in contact with the animal bedding being thrown by the opposing rotor 200 or 202. This contact will further assist in dislodging contaminants from the animal bedding, which contaminants are moved to the vacuum 208 through the vacuum hose 206. While the rotors are parallel to the direction of travel in this embodiment, it will be obvious to those of ordinary skill in the art from the disclosure herein that two animal bedding streams may be created and directed toward each other by one or more rotors either perpendicular to the direction of travel of the cleaner, parallel to the direction of travel for the cleaner, or at any other angle to the direction of travel for the cleaner. For example, snow blowers and snow blower rotors and blades are configured to create a single stream of snow from a ground surface and direct the single stream to an alternative location. Similar single blades may be fashioned to create two streams of material that can be redirected by a routing passageway, or two or more separate rotors may be used to create two or more streams of animal bedding which collide with the other streams of animal bedding to dislodge contaminants.

Modifications of this design may also be used to remove the animal bedding from the stall for cleaning and disinfecting at an alternate location. For cleaning in situ, pursuant to the second aspect of the present invention, heat, steam, disinfectant or other disinfecting medium may be applied inside of the shroud of any embodiment of the invention described herein to disinfect the animal bedding while it is being cleaned, or as a disinfecting method after contaminants are removed from the animal bedding.

In particular embodiments of the present invention, the blower-vacuum of the first embodiment of the invention may be combined with the mechanical agitation of later embodiments of the invention to provide a device in which the animal bedding is mechanically moved to and placed into a fluid stream, such as an air stream. For example, in FIG. 11, a blowing fluid stream may be released into the shroud near a bottom edge 126 of the shroud to blow toward the vacuum hose 118. When the mechanical rotors drop the animal bedding into the fluid stream, the air stream carries the lighter contaminants into the vacuum hose 118 and vacuum 106. The heavier animal bedding 108 drops to the ground through gravitational separation.

In another particular embodiment of the invention, mechanical separation, may be used to move material to be cleaned from a target area into a fluid stream, like that used with the second embodiment of the invention, which draws the contaminated material into a separator. The separator separates contaminants from the material to be cleaned. The material may then be returned to the target area or to a different area.

The use of mechanical agitation with the vacuum air stream and/or mechanical agitation with the blowing, allows the animal bedding cleaning system to use lower power vacuum and blower units than otherwise would be necessary using an air stream without any mechanical agitation. By mechanically placing the contaminated animal bedding 108 into the fluid stream or turbulence zone rather than solely stirring the animal bedding with an air-stream induced turbulence zone, the turbulence caused by the vacuum need not be as strong and/or will be more effective at separating contaminants from the animal bedding. Similarly, by adding a blower below where the animal bedding is dropped to further enhance the air stream, lower powers are required. The precise vacuum, blower, and mechanical agitator power required for a particular application depends upon the weights of the contaminants, the material to be cleaned, the dimensions of the shroud, vacuum and blower, and the respective other powers used. It is believed that the electrical power needed for most applications may be supplied through a standard 120 V outlet.

FIG. 17 illustrates a cross-sectional view of a sixth embodiment of the invention involving mechanical agitation and movement of the animal bedding combined with a vacuum removing contaminants. The animal bedding cleaning system 170 of the embodiment shown in FIG. 17 includes a vacuum/filter system 172 such as those which have been shown and described previously herein. The mechanical agitation portion of the cleaning system 170 includes at least two conveyor-like belts 174 supported by roller wheels 176. A scoop or guide 178 is included on a front end of the cleaning system 170 to convey animal bedding into the belts 174. Additional mechanical agitation such as a rotating brush (i.e. used in a vacuum cleaner) may be used to force the animal bedding to the belts 174. The belts 174 are rotated on the supporting roller wheels 176 to convey the animal bedding and any contaminants toward the vacuum hose 180. The gap between the belts 174 is small enough to break up any larger contaminants, such as manure pieces, into smaller contaminant pieces before they reach the vacuum hose 180. To further encourage the break-up of the manure pieces, the upper belt 174 may be rotated at a speed different from the lower belt 174 to create a grinding effect on the material passing there between. Once the animal bedding and contaminants have passed the belts, it is released into the turbulence zone 182. The lighter contaminant materials are drawn to the vacuum hose 180 by vacuum pressure caused by the vacuum 172, and the heavier animal bedding materials are dropped back into the stall. Any of the turbulence zones or other mechanical agitation examples provided in the present invention may be added into the turbulence zone of the present embodiment for further separation of animal bedding from contaminants. Additionally, the mechanical grinding provided by this embodiment may be added into other embodiments, for example, to break up contaminants before passing them for separation.

For each of the embodiments of shredding tines, rotors, mechanical agitators, wheels, and belts shown and described herein, the materials with which the respective components is formed will depend upon what is needed for a particular application, though all conventional materials are contemplated. Examples of materials with which the components may be formed include, but are not limited to, plate, molded or cast metal or steel components, such as is conventionally used for forming garden roto-tillers and other yard equipment, hardened molded or extruded plastic, rubber, silicon or urethane. For each of these components, which are commonly used in the manufacture of garden and yard tools as well as vacuum systems, various grades and qualities of materials exist. Those which are designed to be wear resistant are longer lasting and more desirable for use with hard or abrasive animal bedding.

Embodiments of the present invention may also be adapted to remove heavy contaminant materials from lighter animal bedding materials. For example, organic bedding material such as straw, shredded paper, saw dust and the like, and some inorganic bedding materials such as cat litter, absorb urine or clump with urine or feces and become unusable due to the contaminants, but are heavier than the remaining bedding or litter materials. By adapting the embodiments of the present invention to preserve the lighter materials and dispose of the heavier materials, and by selecting appropriate vacuum, blower, and/or mechanical agitator powers, the soiled bedding and litter may be separated from the unsoiled material for reuse if so desired. Those of ordinary skill in the art will be able to readily determine appropriate power levels based upon the specific characteristics of the material to be cleaned and the cleaning system being used. The separated lighter bedding and litter material may thereafter need to be further cleaned and disinfected to remove other lighter contaminants, but initial cleaning to remove heavier contaminants may be accomplished and is contemplated through embodiments of the present invention.

It will be understood by those of ordinary skill in the art that more simple embodiments of the invention may be configured to be light and small enough for a user to carry on the user's back or shoulder or push simply by hand. More complex embodiments, however, due to size and/or weight considerations, may be placed on a structure having wheels to be pulled by a user for use adjacent to a target area to be cleaned, or may be drawn or carried by a motored vehicle such as a truck, a tractor or a smaller vehicle such as an all-terrain vehicle (commonly called an ATV). For embodiments of the invention where the vacuum unit is not within or directly adjacent to the animal bedding to be cleaned, additional power must be supplied to the vacuum and/or blower motors to cause the animal bedding to travel a greater distance through the inlet and outlet nozzles or to allow for greater volumes of animal bedding to be cleaned. For example, it is contemplated that individual or combined vacuum/blower motors may even range up to between 100-300 HP for particular applications. However, those of ordinary skill in the art will be able to determine the vacuum, mechanical agitator and blower powers needed for a particular cleaning system configuration taking into account the lengths and dimensions of the hoses extending to and from the cleaning system, the density and depth of the particular bedding being cleaned, and the collective sizes of the blower, vacuum and shroud openings.

It is contemplated that embodiments of the invention may be used to clean animal bedding for use within the region from which the bedding originated, or for use in a different region. For example, a horse stall may be cleaned and the animal bedding returned to the cleaned stall as discussed above, or the cleaned bedding may be placed in a different stall in the same or a different horse stall complex. Additional disinfection may be performed prior to placing the bedding at its final location. An embodiment of the invention may be configured with a large container or truck bed for storing and transporting cleaned animal bedding for use elsewhere. It is also contemplated that used animal bedding may be dropped-off by an animal owner or otherwise transported to a central location and then cleaned and disinfected in bulk at that location for later re-use. There are many ways that animal bedding may be re-used or otherwise recycled for use as animal bedding or for other use through embodiments of the present invention.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, it will be clear to those of ordinary skill in the art that embodiments of the present invention may be particularly helpful for removing contaminants from other granular materials which are hard and relatively heavier than the respective contaminants. Embodiments of the invention are not limited specifically to use with animal bedding.

1. A method of cleaning animal bedding, the method comprising mechanically agitating contaminated animal bedding and removing contaminants from the agitated animal bedding in an air stream.

2. The method of claim 1, the method further comprising:
moving contaminated animal bedding from a target area into the air stream by mechanical agitation;
separating contaminants from the contaminated animal bedding while the contaminants are in the air stream; and
returning the animal bedding to the target area.

3. The method of claim 2, wherein separating the contaminants from the animal bedding while the contaminants are in the air stream comprises mechanically throwing the contaminated animal bedding against a surface by which the air stream passes and drawing the contaminants away from the animal bedding by vacuum pressure.

4. The method of claim 1, further comprising generating a turbulence zone within a shroud and separating the animal bedding from the contaminants at least in part by gravity separation.

5. The method of claim 1, further comprising destroying germs among the animal bedding through exposing the animal bedding to a disinfecting medium.

6. A method of cleaning animal bedding having a predetermined density, the method comprising:
mechanically moving the animal bedding into an air stream; and
air vacuuming the animal bedding with a vacuum force sufficient to remove contaminants from the animal bedding but not remove the animal bedding.

7. The method of claim 6, further comprising throwing the animal bedding against a surface stationary with respect to a mechanical agitator moving the animal bedding after mechanically moving the animal bedding.

8. The method of claim 6, wherein mechanically moving the animal bedding comprises tossing the animal bedding with a rotary blade to enhance separation of the contaminants from the animal bedding.

9. The method of claim 6, wherein the predetermined density is greater than approximately 20 lb/ft³.

10. The method of claim 6, further comprising creating a turbulence zone within an enclosed shroud through simultaneous mechanical moving and vacuuming of the animal bedding.

11. A method of cleaning contaminated animal bedding for reuse, the method comprising:
mechanically agitating the contaminated animal bedding with a rotary blade;
passing the agitated animal bedding through an air stream;
separating contaminants from the animal bedding in the air stream; and
destroying germs among the animal bedding while separating the contaminants from the animal bedding.

12. The method of claim 10, wherein destroying germs among the animal bedding comprises exposing the suspended animal bedding to a disinfecting medium.

13. The method of claim 10, wherein separating contaminants from the bedding comprises separating within an enclosed shroud.

14. The method of claim 10, wherein separating contaminants from the animal bedding comprises separating using cyclonic separation.

15. An animal bedding cleaning system for removing contaminants from animal bedding, the system comprising:
a mechanical agitator configured to direct animal bedding into an impact plate; and
a vacuum coupled to the mechanical agitator and configured to create a vacuum-induced air stream adjacent to the impact plate, the air stream configured to draw contaminants from among the animal bedding into the vacuum.

16. The animal bedding cleaning system of claim 15, wherein the mechanical agitator comprises at least two agitator blades.

17. The animal bedding cleaning system of claim 15, further comprising a shroud surrounding at least a portion of the mechanical agitator and coupled to the impact plate.

18. The animal bedding cleaning system of claim 17, wherein the shroud comprises a continuous perimeter around the mechanical agitator and is open on a bottom side.

19. The animal bedding cleaning system of claim 15, wherein the vacuum unit is a cyclonic vacuum unit configured to separate contaminants from the air stream.

20. The animal bedding cleaning system of claim 19, wherein the vacuum unit is further configured to separate a first category of contaminants from a second category of contaminants.

21. The animal bedding cleaning system of claim 20, wherein the first and second categories of contaminants are categorized by density.

22. The animal bedding cleaning system of claim 15, wherein the mechanical agitator rotates about an axis substantially parallel to the impact plate.

23. An animal bedding cleaning system for removing contaminants from animal bedding, the system comprising:
a mechanical agitator at least partially housed in a shroud having an open bottom side, the mechanical agitator configured to move the animal bedding and contaminants from the open bottom side of the shroud to an impact plate; and
a vacuum configured to create a vacuum-induced air stream within the shroud adjacent the impact plate, the air stream configured to draw contaminants from the animal bedding into the vacuum unit.

24. The animal bedding cleaning system of claim 23, wherein the mechanical agitator comprises at least two agitator blades configured to rotate about an axis substantially parallel to the impact plate.

25. The animal bedding cleaning system of claim 23, wherein the vacuum unit is a cyclonic vacuum unit configured to separate contaminants from the air stream.

26. The animal bedding cleaning system of claim 25, wherein the vacuum unit is further configured to separate a first category of contaminants from a second category of contaminants.

27. The animal bedding cleaning system of claim 26, wherein the first and second categories of contaminants are categorized by density.
